(19) United States
(12) Patent Application Publication
(10) Pub. No.: US 2007/0271845 A1
(43) Pub. Date: Nov. 29, 2007

(54) Explosion-venting door structure

(76) Inventor: Wen Ming Chang, Taipei (TW)

Correspondence Address: BACON & THOMAS, PLLC, 625 SLATERS LANE, FOURTH FLOOR, ALEXANDRIA, VA, 22314, US

(21) Appl. No.: 11/441,151

(22) Filed: May 26, 2006

(51) Int. Cl. E05F 15/20

(52) U.S. Cl. 49/31

(57) ABSTRACT

An explosion-venting door structure includes a doorframe having a top rail, a middle rail, and a bottom rail, a first door panel, which has a top mounting flange hinged to the bottom side of the top rail and a beveled bottom edge matching a beveled top edge of the middle rail, and a second door panel, which has a top mounting flange hinged to the bottom side of the middle rail and a beveled bottom edge matching a beveled top edge of the bottom rail.

### BACKGROUND OF THE INVENTION

1. Field of the Invention

The present invention relates to a safety door structure and more specifically, to an explosion-venting door structure that is engineered to afford superior pressure venting protection and that seals out rainwater when closed.

2. Description of the Related Art

Explosion-venting doors are commonly used in warehouses and plants and engineered to afford pressure relief protection under a predetermined pressure condition, for example, an accidental explosion. These conventional explosion-venting doors commonly have a doorframe and a door panel mounted in the doorframe. The door panel is opened under a predetermined pressure condition. However, because gaps are left in between the doorframe and the top and bottom sides of the door panel, rainwater may pass through the gaps to wet the indoor space as the door is closed during a rainy day.

### SUMMARY OF THE INVENTION

The present invention has been accomplished under the circumstances in view. It is therefore the main object of the present invention to provide an explosion-venting door structure, which affords superior pressure venting protection and effectively seals out raining water.

To achieve this and other objects of the present invention, the explosion-venting door structure comprises a doorframe and a door panel mounted in the doorframe. The doorframe has a top rail, a middle rail, and a bottom rail. The two door panels each have a top mounting flange respectively hinged to the bottom side of the top rail and the bottom side of the middle rail, a beveled bottom edge respectively matching a beveled top edge of the middle rail and a beveled top edge of the bottom rail.

### BRIEF DESCRIPTION OF THE DRAWINGS

FIG. 1 is a front view of an explosion-venting door structure in accordance with the present invention.

FIG. 2 is an exploded view of a part of the explosion-venting door structure according to the present invention.

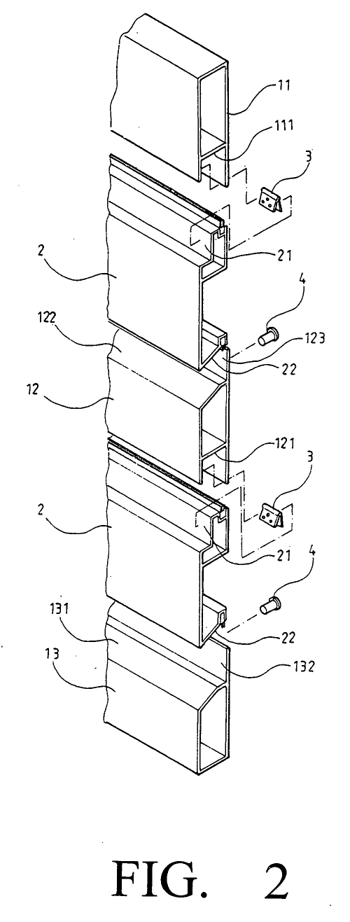

FIG. 3 is a sectional side assembly view of the explosion-venting door structure according to the present invention.

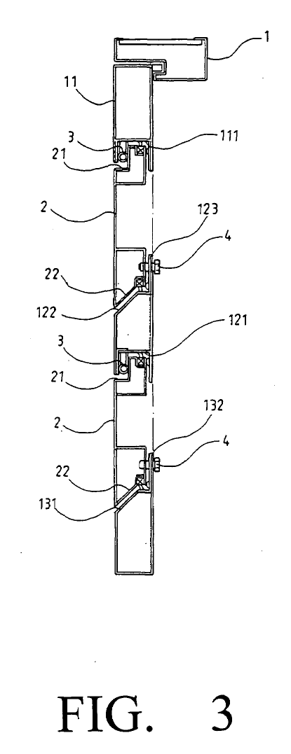

FIG. 4 is a schematic drawing showing the door panels opened upon an explosive pressure.

### DETAILED DESCRIPTION OF THE PREFERRED EMBODIMENT

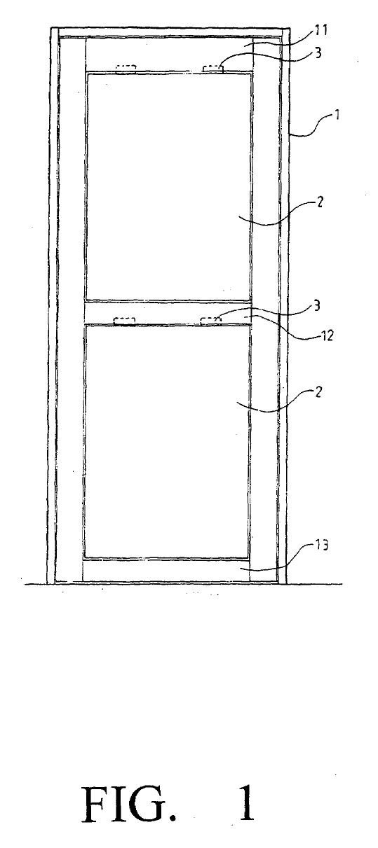

Referring to FIGS. 1˜3, an explosion-venting door structure in accordance with the present invention is shown comprised of a doorframe 1 and two door panels 2.

The doorframe 1 has a top rail 11 transversely disposed at the top side, a bottom rail 13 transversely disposed at the bottom side, and a middle rail 12 transversely disposed on the middle between the top rail 11 and the bottom rail 13. The top rail 11 has a bottom coupling groove 111 extending along the length of the bottom side thereof. The middle rail 12 has a bottom coupling groove 121 extending along the length of the bottom side thereof, a beveled top edge 122 disposed at the top side, and a top mounting flange 123 vertically upwardly extending from the topmost edge of the beveled top edge 122. The bottom rail 13 has a beveled top edge 131 disposed at the top side, and a top mounting flange 132 vertically extending from the topmost edge of the beveled top edge 131.

The two door panels 2 are respectively mounted in the doorframe 1 in the gap between the top rail 11 and the middle rail 12 and the gap between the middle rail 12 and the bottom rail 13, each having a top mounting flange 21 respectively hinged to the bottom coupling groove 111 of the top rail 11 and the bottom coupling groove 121 of the middle rail 12 by a respective hinge 3 and a beveled bottom edge 22 respectively matching the beveled top edge 122 of the middle rail 122 and the beveled top edge 131 of the bottom rail 13. Further, explosion-venting bolts 4 are respectively fastened to the top mounting flanges 123 and 132 of the middle rail 12 and bottom rail 13 of the doorframe 1 and the back bottom side of each of the door panels 2, thereby keeping the beveled bottom edges 22 of the door panels 2 respectively abutted against the beveled top edge 122 of the middle rail 122 and the beveled top edge 131 of the bottom rail 13.

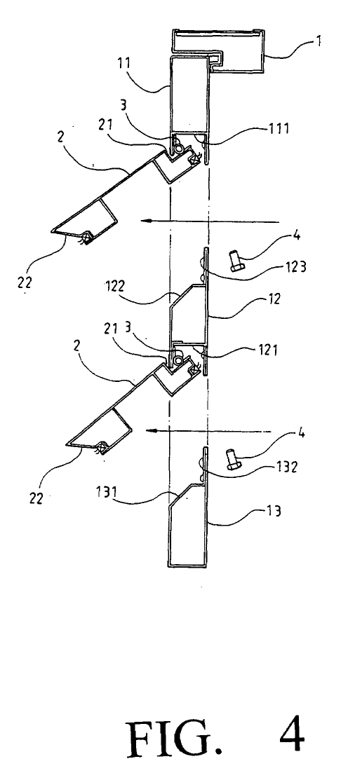

Referring to FIG. 4, when an explosion occurred, the pressure-venting bolts 4 break upon the explosive pressure, enabling the door panels 2 turned outwards (about the pivot of the respective hinge) relative to the doorframe 1 to relieve the explosive pressure. After the explosion, the door panels 2 are fastened to the top mounting flanges 123 and 132 of the middle rail 12 and bottom rail 13 of the doorframe 1 with new explosion-venting bolts 4 again.

Although a particular embodiment of the invention has been described in detail for purposes of illustration, various modifications and enhancements may be made without departing from the spirit and scope of the invention.

What the invention claimed is:

1. An explosion-venting door structure comprising:
a doorframe, said doorframe having a top rail transversely disposed at a top side thereof, a bottom rail transversely disposed at a bottom side thereof, and a middle rail transversely disposed between said top rail and said bottom rail, said top rail having a bottom coupling groove extending along the length of a bottom side thereof, said middle rail having a bottom coupling groove extending along the length of a bottom side thereof and a beveled top edge disposed at a top side thereof, said bottom rail having a beveled top edge disposed at a top side thereof; and
two door panels respectively mounted in said doorframe in gaps between said top rail and said middle rail and between said middle rail and said bottom rail, said door panels each having a top mounting flange respectively hinged to the bottom coupling groove of said top rail and the bottom coupling groove of said middle rail, and a beveled bottom edge respectively matching the beveled top edge of said middle rail and the beveled top edge of said bottom rail.

2. The explosion-venting door structure as claimed in claim 1, wherein said middle rail has a top mounting flange vertically upwardly extending from the topmost edge of said middle rail; said bottom rail has a top mounting flange vertically upwardly extending from the topmost edge of the beveled top edge of said bottom rail; said door panels each have a back wall respectively fastened to the top mounting flange of said middle rail and the top mounting flange of said bottom rail with a respective explosion-venting bolt.
